(19) United States
(12) Patent Application Publication
(10) Pub. No.: US 2026/0175878 A1
(43) Pub. Date: Jun. 25, 2026

(54) REFUSE COLLECTION VEHICLE BATTERY CHARGING

(71) Applicant: The Heil Co., Chattanooga, TN (US)

(72) Inventors: Phillip A. Kendrick, Chattanooga, TN (US); Joseph Henry Mills, Dunwoody, GA (US)

(21) Appl. No.: 19/424,073

(22) Filed: Dec. 17, 2025

Related U.S. Application Data
(60) Provisional application No. 63/738,084, filed on Dec. 23, 2024.

(51) Int. Cl. B60W 60/00; G01C 21/34; G01C 21/36; G08G 1/00

(52) U.S. Cl. CPC B60W 60/0023; B60W 60/0025; G01C 21/3469; G01C 21/3691; G08G 1/22; B60W 2510/244

(57) ABSTRACT

A computer-implemented method performed by at least one processor, the method comprising: obtaining vehicle information for a fleet of vehicles, the vehicle information comprising, for each vehicle of the fleet of vehicles, battery charge data for at least one battery of the respective vehicle; obtaining, for each route of a plurality of routes, route information; automatically assigning, for each route of the plurality of routes based on the vehicle information and the route information, a respective vehicle of the fleet of vehicles to a respective route of the plurality of routes; and outputting assignment data that indicates the assigned vehicle for each of the plurality of routes. In some cases, the fleet of vehicles comprises a fleet of refuse collection vehicles. In some cases, the plurality of routes comprises a plurality of refuse collection routes.

### CROSS-REFERENCE TO RELATED APPLICATION

This application claims the benefit of the U.S. Provisional Ser. No. 63/738,084, filed Dec. 23, 2024, which is incorporated herein by reference in its entirety.

### TECHNICAL FIELD

This disclosure relates to the field of refuse collection, storage, and disposal.

### BACKGROUND

Refuse collection vehicles are typically used to pick up quantities of refuse (e.g., garbage, waste, recyclables, etc.) for hauling to a designated area, such as a landfill, transfer station, or material recovery facility. Ground transportation logistics, such as collection route planning for refuse collection vehicles, involves a highly complex nature of operations and numerous operational constraints. Ground transportation routing can be impacted by dynamically changing environmental, mechanical, and logistical factors. It is desirable to efficiently manage power consumption of power supplies and replenishment of power supplies for refuse collection vehicles, while also ensuring that collection schedules meet user requirements of cost and service levels while balancing capacity requirements.

### SUMMARY

Some implementations of this disclosure feature a computer-implemented method performed by at least one processor, the method including: obtaining vehicle information for a fleet of vehicles, the vehicle information including, for each vehicle of the fleet of vehicles, battery charge data for at least one battery of the respective vehicle; obtaining, for each route of a plurality of routes, route information; automatically assigning, for each route of the plurality of routes based on the vehicle information and the route information, a respective vehicle of the fleet of vehicles to a respective route of the plurality of routes; and outputting assignment data that indicates the assigned vehicle for each of the plurality of routes.

In some implementations, the vehicle information includes at least one of: a volumetric fullness of a storage container of each respective vehicle of the fleet of vehicles; a capacity of a storage container of each respective vehicle of the fleet of vehicles; or an operational status of each respective vehicle of the fleet of vehicles.

In some implementations, the battery charge data includes at least one of: a state of charge of the at least one battery of the respective vehicle; or a battery capacity of the at least one battery of the respective vehicle.

In some implementations, the at least one battery includes a chassis battery configured to provide electrical power to a chassis of the vehicle.

In some implementations, the at least one battery includes a body battery configured to provide electrical power to one or more body components of the vehicle.

In some implementations, the route information for a route of the plurality of routes includes at least one of: a length of the route; a predicted duration of the route; or a number of service events assigned to the route.

In some implementations, the route information includes a set of initial conditions for each route of a plurality of routes; and assigning a vehicle to a particular route includes determining, based on the vehicle information, that the vehicle satisfies the initial conditions for the particular route.

In some implementations, the set of initial conditions includes at least one of: a minimum battery state of charge required to perform the respective route; or a minimum storage container capacity required to perform the respective route.

In some implementations, the set of initial conditions varies depending on environmental conditions.

In some implementations, the route information includes a set of initial conditions for each route of a plurality of routes; and assigning the respective vehicle to the respective route includes: determining, based on the vehicle information, that the respective vehicle does not satisfy the initial conditions for the respective route; and identifying one or more actions that would result in the respective vehicle satisfying the initial conditions for the respective route; and outputting instructions to perform the one or more actions that would result in the respective vehicle satisfying the initial conditions for the respective route.

In some implementations, the vehicle information includes a volumetric fullness of a storage container of the respective vehicle, and the one or more actions include emptying the storage container of the respective vehicle.

In some implementations, the one or more actions include charging the at least one battery of the respective vehicle.

In some implementations, the route information includes a schedule for performance of the respective route.

In some implementations, the route information includes a predicted battery power consumption for the respective route.

In some implementations, the route information includes a set of initial conditions for the respective route, and the method includes determining, for each route of the plurality of routes based on historical route information, initial conditions for the respective route.

In some implementations, the historical route information includes at least one of: a time duration of multiple instances of performance of the respective route; battery power consumed during the multiple instances of performance of the respective route; a number of service events performed during the multiple instances of performance of the respective route; or environmental conditions during the multiple instances of performance of the respective route.

In some implementations, the plurality of routes includes a plurality of routes to be performed in a geographic region over a specified time period.

In some implementations, the method includes obtaining charger information for each charger of a plurality of chargers; and assigning the respective vehicle of the fleet of vehicles for each route of the plurality of routes based on the vehicle information, the route information, and the charger information.

In some implementations, the charger information indicates at least one of: an operational status of the respective charger; a charging rate of the respective charger; one or more electrical specifications of the respective charger; or a location of the respective charger.

In some implementations, automatically assigning, for each route of the plurality of routes based on the vehicle information and the route information, a respective vehicle of the fleet of vehicles to a respective route includes: processing the battery charge data and the route information with a routing model; and obtaining the assignment of each route to a respective vehicle as output from the routing model.

In some implementations, the routing model includes one or more machine learning models.

In some implementations, the routing model assigns the vehicles based on optimizing at least one objective function.

In some implementations, the method includes receiving user input specifying the at least one objective function to be optimized.

In some implementations, objective function includes a function for at least one of: a utilization of a plurality of chargers; a total battery charging time for the fleet of vehicles; a total number of vehicles to be charged; battery cycling for the fleet of vehicles; and a utilization of storage container capacity for the fleet of vehicles.

In some implementations, the assignment data instructs, for each assigned vehicle, at least one of: whether to charge the at least one battery of the vehicle; a time duration of charging the at least one battery of the vehicle; a final state of charge for the at least one battery after charging the at least one battery of the vehicle; or an assigned charger for charging the at least one battery of the vehicle.

In some implementations, the assignment data instructs, for a vehicle, an assigned charger for charging the at least one battery of the vehicle; and outputting the assignment data includes transmitting instructions to the assigned charger to charge the vehicle for a specified time duration or to a specified state of charge.

In some implementations, outputting the assignment data includes outputting, to a vehicle, display data for presentation by a display of the vehicle. The display data shows the respective route.

In some implementations, the fleet of vehicles includes at least one autonomous vehicle; and outputting the assignment data includes transmitting instructions to the at least one autonomous vehicle to perform the respective route.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

Particular implementations of the subject matter described in this specification can be implemented so as to realize one or more material advantages, such as improved operational efficiency and energy conservation. For example, the described techniques can be implemented in order to optimize charging efficiency for a fleet of vehicles such as refuse collection vehicles. This can reduce the number of chargers required for maintaining the fleet of vehicles, while ensuring completion of assigned routes. The disclosed implementations can reduce the total amount of charging time for a fleet of vehicles in between driving shifts.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system for managing refuse collection vehicle battery charging.

FIG. 2 depicts an example routing model for managing refuse collection vehicle battery charging.

FIG. 3 depicts an example system for training a routing model for managing refuse collection vehicle battery charging.

FIG. 4 depicts an example refuse collection vehicle.

FIG. 5 is a flowchart of a process for managing refuse collection vehicle battery charging.

FIG. 6 is a diagram depicting a control system for controlling one or more operational components of a refuse collection vehicle.

### DETAILED DESCRIPTION

This disclosure relates to systems and methods for refuse collection vehicle battery charging. A route management system monitors statuses of a fleet of refuse collection vehicles and of multiple chargers. The route management system assigns individual vehicles to chargers and to collection routes in order to optimize charging efficiency while providing vehicles with enough battery charge to perform their assigned routes.

An operator of a fleet of vehicles may have a greater number of electric vehicles than they have charging infrastructure to fully support the vehicles. Therefore, the operator may only be able to charge a portion of the vehicle fleet back to 100% state of charge before the next day of business. The disclosed implementations can selectively assign a vehicle to a particular route based on factors such as current battery state of charge and forecasted route power consumption.

It is generally uncommon for an electric refuse collection vehicle to fully deplete its battery or batteries during performance of a refuse collection route. By analyzing battery state of charge before, during, and after a route, a route management system can determine the average power needs for a given route. This data can then be used to match the required state of charge for a route with the current state of charge of vehicles in the fleet, and assign a specific vehicle to a specific route based on identifying the vehicles that have sufficient battery power to complete that route with no, or only partial, charging. This will allow an operator to only charge the vehicles that require charging, and to only charge them to the state of charge necessary to complete the assigned route. This can enable the operator to operate more vehicles than the number of chargers available, increasing utilization of the vehicle and reducing the amount of down-time caused by unnecessarily charging beyond a given demand.

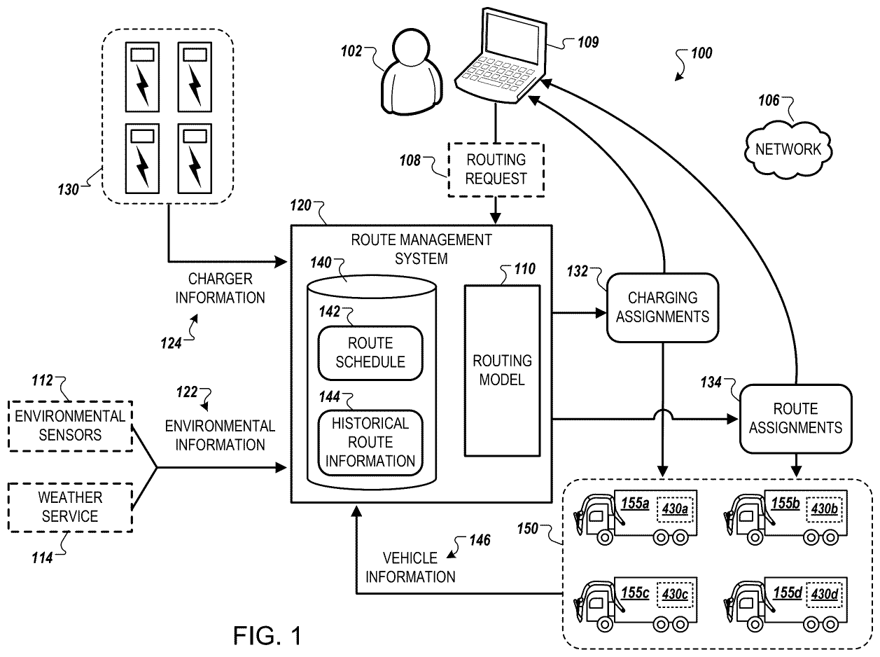

FIG. 1 illustrates an example system 100 for managing refuse collection vehicle battery charging. The system 100 includes a route management system 120 and a user device 109 accessible by a user 102. Each of these components can communicate with one another, e.g., over a data communication network 106. The system 100 can be accessed by more than one user 102. The network 106 can include public and/or private wired or wireless networks, and can include the Internet.

The user device 109 can be an electronic device such as a computing device. The user device 109 can be, for example, a desktop computer, a laptop computer, a smart phone, a cell phone, a tablet, a personal digital assistant (PDA), etc. The user device 109 is accessible by the user 102.

The system 100 includes a fleet 150 of refuse collection vehicles 155a, 155b, 155c, 155d (refuse collection vehicles 155″) that operate to collect and transport refuse. In some examples, the fleet 150 of refuse collection vehicles 155 is a group of refuse collection vehicles 155 that are owned and/or operated by a common organization (e.g., a waste management organization). In some examples, the fleet 150 of refuse collection vehicles 155 is a group of refuse collection vehicles 155 that operate within a common geographic region (e.g., a town, a city, a county). The fleet 150 of refuse collection vehicles 155 can include refuse collection vehicles of various types and sizes. For example, the fleet 150 of refuse collection vehicles can include front-loaders, rear-loader, side-loaders, roll-off, and so forth, with or without Curotto-Can™ or carry can.

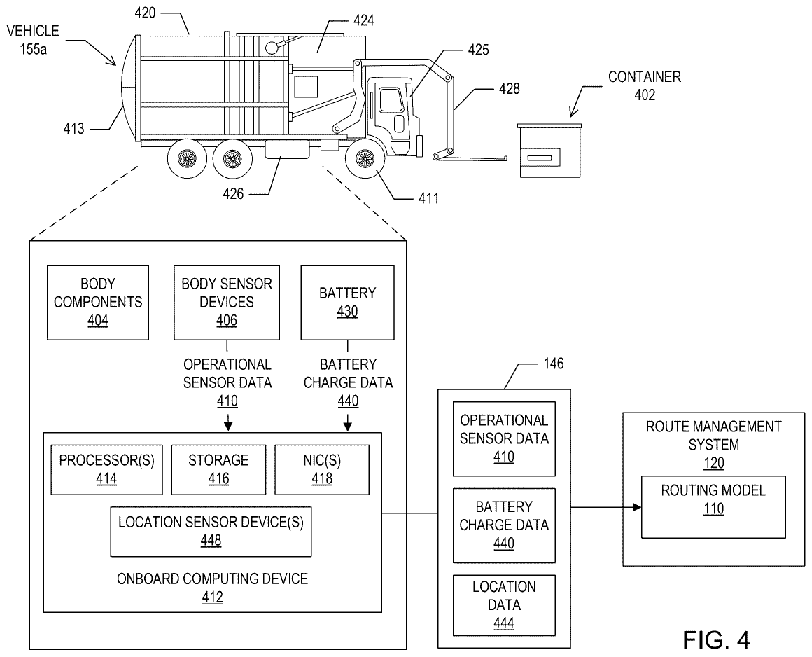

The refuse collection vehicles 155 can each include batteries. For example, referring to FIG. 1, each of the refuse collection vehicles 155a, 155b, 155c, 155d has a respective battery 430a, 430b, 430c, 430d. The battery or batteries of a refuse collection vehicle provide electrical power to components of the refuse collection vehicle such as a chassis and/or components of a refuse collection body. Body components of refuse collection vehicles are described in greater detail with reference to FIG. 4. The battery or batteries can be replenished using charging devices.

Charging devices may be installed at or near a depot where the refuse collection vehicles 155 are stored. In some examples, refuse collection vehicles 155 perform refuse collection during a collection time window (e.g., during daytime) and return to the depot during a storage time window (e.g., overnight). The routine can repeat on a schedule such as a daily, semi-daily, or weekly schedule. Some or all of the batteries of the refuse collection vehicles can be recharged, during the storage time window and/or between consecutive collection time windows.

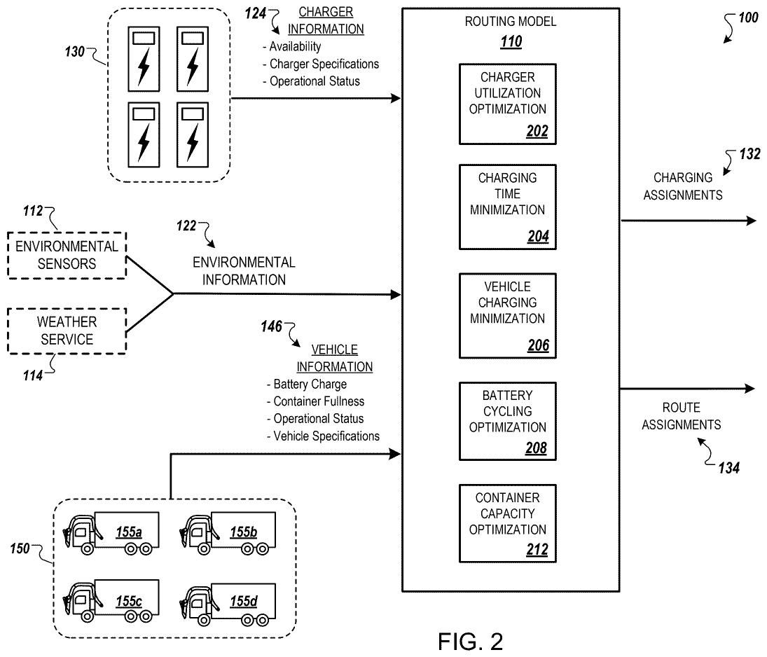

The fleet 150 of refuse collection vehicles 155 sends vehicle information 146 to the route management system 120. In some examples, each refuse collection vehicle 155 sends vehicle-specific vehicle information 146 to the route management system. Referring to FIG. 2, the vehicle information 146 for a particular refuse collection vehicle can include: a battery state of charge of at least one battery of the refuse collection vehicle, a container fullness, an operational status of the vehicle, vehicle specifications, a location of the vehicle, and/or other information about the fleet 150 of refuse collection vehicles 155. Specifications of the vehicle can include, for example, a maximum speed, a maximum continuous travel range, a horsepower, a maximum environmental temperature for operations, a minimum environmental temperature for operations, a predicted battery consumption rate, or any combination thereof.

The system 100 includes a set of chargers 130. The chargers 130 operate to charge batteries of the fleet 150 of refuse collection vehicles 155. In some examples, the set of chargers is a group of chargers that are located in a common location (e.g., a vehicle depot, a charging station). In some examples, the set of chargers 130 is a group of chargers that are within a common geographic area (e.g., a neighborhood, a town, a city). The set of chargers 130 can include chargers of various types and specifications. For example, the set of chargers 130 can include normal chargers (e.g., Level 1 chargers, slow chargers, regular chargers, standard chargers), fast chargers (e.g., Level 2 chargers), rapid chargers (e.g., Level 3 chargers, direct current fast chargers (DCFC)), and ultra-rapid chargers. Normal charging is the slowest method, using alternating current (AC) power between about 2 kW and 7 kW. Fast charging is quicker than normal charging, using AC power between about 7 kW and 22 kW. Rapid charging uses direct current (DC) power between about 25 kW and 150 kW. Ultra-rapid charging uses DC power at or greater than 150 kW.

The set of chargers 130 sends charger information 124 to the route management system 120. In some examples, each charger 130 includes a communication module and sends charger-specific charger information 124 to the route management system 120. In some examples, a computing device, such as a charger control system, collects charger information from each charger of the set of chargers 130, and the computing system sends the collected charger information 124 to the route management system. Referring to FIG. 2, the charger information 124 can include, for each respective charger 130, an operational status of the charger, charger specifications, availability of the charger, and/or other information about the set of chargers 130. Availability of the charger can indicate whether the charger is currently available for charging. Availability of the charger can also indicate a schedule for when the charger is expected to be available for charging in the future. Specifications of the charger can include, for example, an amperage, input voltage, battery type, charging rate, charging size, continuous charging time limit, or any combination thereof. An operational status of the charger can indicate whether the charger is functional or non-functional, and/or whether the charger has any operational restrictions. For example, the operational status for a charger can indicate that the charger has a maximum charging rate that is less than indicated by the charger specifications. In another example, the operational status for a charger can indicate that the charger has a maximum charging time limit that is less than indicated by the charger specifications. Operational restrictions can be due to various factors such as maintenance issues and environmental conditions.

The system 100 optionally includes environmental sensors 112. The environmental sensors 112 can be mounted on chargers 130, mounted on vehicles 155, or both. The environmental sensors 112 can include, for example, temperature sensors, humidity sensors, wind sensors, or any combination thereof. The environmental sensors 112 can generate and/or provide environmental information 122 to the route management system 120. The environmental information 122 can include current and/or predicted environmental conditions. Environmental conditions can include, for example, temperature, precipitation, humidity, cloud cover, fog, and wind conditions.

The system 100 optionally includes a weather service 114. The weather service 114 can generate and/or provide environmental information 122 to the route management system 120. In some examples, the weather service 114 provides historical environmental information to the route management system 120. For example, the environmental information 122 can include time-varying temperatures, precipitation amounts, and atmospheric conditions. In some examples, the weather service 114 can provide averaged historical weather data to the route management system 120. For example, the weather service 114 can provide temperatures for each hour of a simulated year, based on averaged historical temperatures. In some examples, the weather service 114 can provide environmental information 122 for geographic locations where refuse collection routes (e.g., collection routes) are scheduled. For example, the environmental information 122 can include historical and/or predicted weather for a county, state, province, town, city, zip code area.

The route management system 120 can be a server system and can include one or more computing devices. In some implementations, the route management system 120 may be part of a cloud computing platform. The route management system 120 includes many computing nodes for performing route management operations. The route management system 120 includes a routing model 110 that can receive, as input, route schedules 142, historical route information 144, environmental information 122, vehicle information 146, charger information 124, or any combination of these. As will be described in further detail herein, the route management system 120 processes the route schedules 142, the historical route information 144, the environmental information 122, the vehicle information 146, and/or the charger information 124 and produces route assignments 134 and charging assignments 132. In general, route assignments 134 include assignment data that matches individual refuse collection vehicles 155 to particular respective routes. Charging assignments 132 include assignment data that matches individual refuse collection vehicles 155 to particular respective chargers. In some cases, the charging assignments 132 instruct vehicle(s) to charge their batterie(s) or not to charge their batterie(s) prior to beginning their assigned route(s).

Charging assignments 132 can include a specified state of charge to target. For example, the route management system 120 can determine that a particular vehicle 155c needs a minimum battery state of charge of 80% to perform its assigned route. The route management system 120 can therefore output a charging assignment 132 that instructs charging the battery 430c of the vehicle 155c to a target of 80% state of charge. In some cases, the charging assignments 132 instruct charging the battery to the minimum battery state of charge plus a margin (e.g., 5%). In this case, the route management system 120 can output a charging assignment 132 that instructs charging the battery 430c of the vehicle 155c to a target of 85% state of charge. The route management system 120 can specify a target state of charge in order to avoid overcharging vehicles. This can reduce the amount of time needed to charge each vehicle. For example, when the vehicle 155c reaches the target state of charge of 85%, the vehicle 155c can depart from the assigned charger, allowing another vehicle 155 to charge its battery.

In some cases, a vehicle 155 can receive a route assignment 134 and might not receive a charging assignment 132. For example, the route management system 120 can assign a particular vehicle (e.g., vehicle 155a) to a particular route, and determine that a state of charge of the battery 430a of the vehicle 155a is greater than a minimum state of charge required to perform the assigned route. The route management system 120 can therefore output a route assignment 134 to the vehicle 155a, without outputting a charging assignment 132 to the vehicle 155a. In some examples, the route management system 120 outputs a charging assignment 132 to the vehicle 155a, and the charging assignment 132 instructs the vehicle 155a not to charge the battery 430a prior to performing the assigned route.

In some examples, a vehicle 155 can receive a charging assignment 132 and might not receive a route assignment 134. For example, the route management system 120 can determine that a particular vehicle 155b is not needed in order to perform the required routes according to the route schedule 142. The route management system 120 can therefore output a charging assignment 132 to the vehicle 155b, without outputting a route assignment 134 to the vehicle 155b. The charging assignment 132 may instruct the vehicle 155b to charge at a later time, compared to other vehicles 155 that have received a route assignment 134. For example, the charging assignment 132 for the vehicle 155b can instruct the vehicle 155b to charge the battery 430b during a time when other vehicles of the fleet 150 are performing their assigned routes.

In general, the user 102 can optionally provide a routing request 108 to a route management system 120 through the user device 109. In some examples, the routing request specifies one or more objective functions to be optimized. The route management system 120 can provide the charging assignments 132 and the route assignments 134 to the refuse collection vehicles 155, the user device 109, or both. The route assignments 134 assign a particular refuse collection vehicle 155 to a particular route. The charging assignments 132 identify refuse collection vehicles 155 that are to be charged before beginning their next assigned route. The route assignments 134, charging assignments 132, and objective functions are described further with reference to FIG. 2.

In some examples, no routing request 108 is received, and the route management system 120 generates the charging assignments 132 and the route assignments 134 automatically. For example, the route management system 120 can generate the charging assignments 132 and the route assignments 134 on a schedule (e.g., daily, weekly) based on the information 122, 124, 128 provided to the routing management system 120. In some examples, upon completion of a set of collection routes, the route management system 120 automatically generates the charging assignments 132 and the route assignments 134 for a next set of collection routes. For example, at the completion of a workday, the route management system 120 can generate the charging assignments 132 and the route assignments 134 for the next workday, the next two workdays, the next three workdays, etc.

In some examples, data representing the route schedule 142 can be stored in one or more databases 140. In some examples, the route schedule 142 can be updated routinely in order to reflect newly added routes, newly removed routes, and modified routes. In some examples, the route schedule 142 can include a list of routes scheduled within a specified time duration, such as a day, a week, or a month. In some examples, the route schedule 142 includes a repeating schedule, such as a schedule that repeats on a daily, weekly, monthly, or yearly basis. The route schedule 142 can include a start time for each route of the set of collection routes.

In some examples, the route schedule 142 can include, for each route, a starting location, a stopping location, a path to be traveled, and a number of assigned service events. The route schedule 142 can include a list of customers that are scheduled to be serviced along the route. The route schedule 142 can include a total travel distance of the route, an expected time to complete the route, an estimated stop time for the route, or any combination thereof.

The database 140 can store historical route information 144 that can be collected over a period of time, (e.g., a number of weeks, months, or years). In some examples, the historical route information 144 can include averaged route data. For example, the historical route information 144 can include a transit time for a particular route, averaged over multiple days, weeks, months, or years. In another example, the historical route information 144 can include a number of service events occurring along the route, averaged over time.

Referring to FIG. 4, an example refuse collection vehicle 155a is depicted according to implementations of the present disclosure. As shown in the examples of FIG. 4, a vehicle 155a can include any suitable number of body components 404. The vehicle 155a can be an RCV that operates to collect and transport refuse (e.g., garbage). The refuse collection vehicle can also be described as a garbage collection vehicle, or garbage truck. The vehicle 155a can be configured to lift containers 402 that contain refuse, and empty the refuse in the containers into a hopper 424 of the vehicle 155a and/or Curotto-Can™ conveyed by the RCV, to enable transport of the refuse to a collection site, compacting of the refuse, and/or other refuse handling activities. The vehicle 155a can also handle containers in other ways, such as by transporting the containers to another site for emptying.

Refuse collection vehicle 155a includes a cab 425, a chassis 426, and a storage container 420. Cab 145 includes a compartment for a driver of vehicle 155a. The compartment is equipped with controls that enable the driver to operate various elements of the chassis 426 and the body components 404 and one or more displays that enable the driver to monitor such elements. The chassis 426 includes a power train (e.g., a diesel, compressed natural gas (CNG), or electric power train). The power train, which includes a prime mover and a drivetrain, converts and transfers motive power to the wheels 411 that move vehicle 155a on a road surface along a forward direction of travel and a rearward direction of travel.

The body components 404 can include various components that are appropriate for the particular type of vehicle 155a. For example, a garbage collection vehicle may be a truck with an automated side loader (ASL). Alternatively, the vehicle may be a front-loading truck, a rear loading truck, a roll off truck, or some other type of garbage collection vehicle. A vehicle with an ASL may include body components involved in the operation of the ASL, such as lift arms and/or a fork, as well as other body components such as a pump, a tailgate, a packer, and so forth. A front-loading vehicle, such as the example shown in FIG. 4, may include body components such as a pump, tailgate, packer, grabber, and so forth. A rear loading vehicle may include body components such as a pump, blade, tipper, and so forth. A roll off vehicle may include body components such as a pump, hoist, cable, and so forth. Body components may also include other types of components that operate to bring garbage into a storage container 420 of the truck via the hopper 424, compress and/or arrange the garbage in the storage container, and/or expel the garbage from the storage container.

In one exemplary (but non-limiting) use-case, vehicle 155a traverses a refuse collection route including numerous (e.g., hundreds) of service stops to pick up residential refuse containers, dump waste into the hopper 424, transfer waste from the hopper 424 into the storage container 420, and compact the waste within the storage container 420. After completing all or a portion of a collection route, vehicle 155a travels to a designated area and ejects the waste from the storage container 420 using an ejector. To eject a load of waste, a tailgate 413 pivots from a closed position to an open position, and the panel of the ejector moves rearward, pushing the load through the tailgate opening (an “eject event”). A set of one or more ejector sensors monitor operation of ejector during such an ejection event.

In some examples, the packer features an auger and an auger drive. The auger resides within hopper 424 and includes a cylindrical tube carrying a helicoid flight on its outer surface. The auger drive is an electric drive including a prime mover in the form of an electric motor. The auger drive rotates the tube of the auger about its longitudinal axis, causing the flight to move like a screw thread. Movement of the flight conveys any waste in the hopper 424 rearward, where it passes through an aperture in the ejector and enters the enclosed volume of the storage container 420. As waste builds up in the storage container 420, rotation of the auger not only transfers new waste from the hopper 424 into the storage container 420 but also pushes the new waste against the existing waste already in the storage container 420. Compacting the waste in this manner decreases its volume and increases the storage capacity of the storage container. The vehicle 155a can include any number of body sensor devices 406 that sense body component(s), and generate operational sensor data 410 describing the operation(s), and/or the operational state of various body components 404. The body sensor devices 406 are also referred to as operational sensor devices, or operational sensors. Operational sensors may be arranged in the body components, or in proximity to the body components, to monitor the operations of the body components. The operational sensors may emit signals that include the operational sensor data 410 describing the body component operations, and the signals may vary appropriately based on the particular body component being monitored. In some implementations, the operational sensor data 410 is analyzed, by a computing device on the vehicle and/or by remote computing device(s).

The operational sensor data 410 can include sensor data indicating a volumetric fullness of the storage container 420. In some examples, the onboard computing device 412 controls the operation of the packer to compact refuse contained within the storage container 420 and is communicatively coupled with a packer load sensor via an information network. The packer load sensor monitors a load imparted on or by the packer and outputs packer load data corresponding to the same. As one example, a packer load sensor may take the form of a torque measuring device (e.g., a rotary or reaction torque transducer, a load cell, etc.) that measures torque applied by a prime mover of the auger drive to another packer component (e.g., the tube of the auger). As another example, the packer load sensor may take the form of a device that measures certain operating characteristics and qualities of the prime mover (e.g., a current or voltage measuring device). The packer load sensor provides a stream of packer load data values. In this example, the data stream includes a plurality of packer load data values ranging between a lower limit and an upper limit. Additionally, in this example, packer load sensor outputs packer load data values according to a predetermined sample rate (e.g., 1 Hz, 10 Hz, or 100 Hz). In some examples, volumetric fullness can be estimated using a weight sensor to measure the weight of the storage container 420. In some examples, volumetric fullness of the storage container can be estimated using other sensor(s) that can estimate an amount of refuse in the storage container. The sensors can include, for example, a camera, a radar sensor, a lidar sensor, an ultrasonic sensor, or any combination thereof.

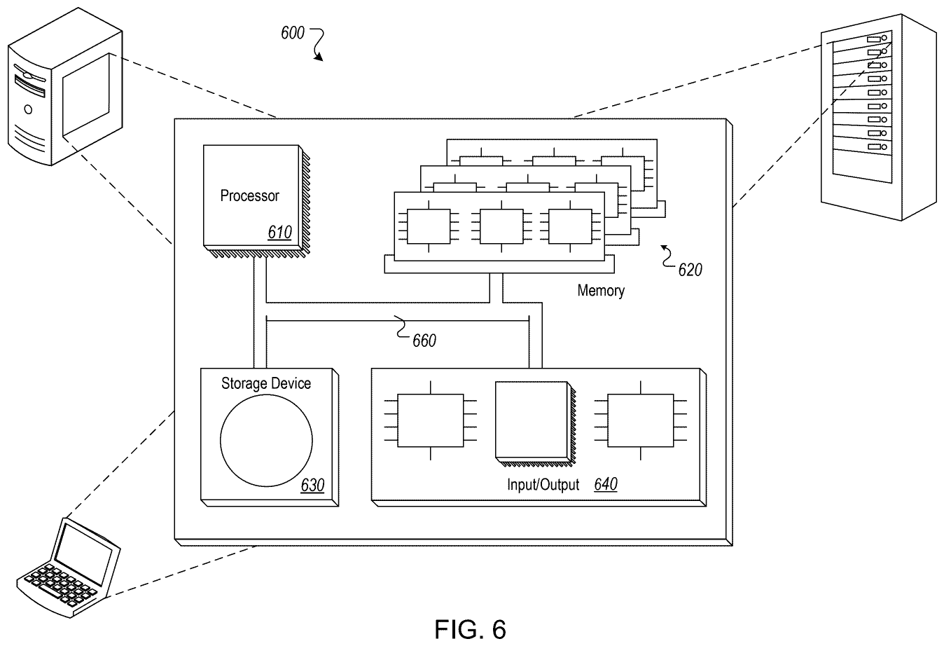

In some examples, the onboard computing device 412 includes a programmable logic controller (PLC) with integral data input/output, memory, and processing components (see, e.g., FIG. 6), and the information network includes an onboard wired data bus. The onboard computing device 412 issues command signals through the information network that cause the auger drive to rotate or cease rotating the auger. The onboard computing device 412 performs control schemes and issues control commands based on packer load data received, via the information network, from packer load sensor. The onboard computing device 412 can also provide, via the information network, information (e.g., data, alerts, etc.) regarding the operation of refuse collection vehicle 155a to a user interface system viewable by a human operator in the vehicle's cab 104.

The onboard computing device 412 can obtain packer load data during a refuse collection route traversed by vehicle 155a. The packer load data can include a varying magnitude of the packer load over time. In some examples, the packer load data includes a series of data points, each data point representing the maximum packer load data value received from the packer load sensor during a packing cycle following a given dump-cycle service event.

During a refuse collection route, the magnitude of the packer load data generally is expected to follow an increasing trendline over time, as the vehicle 155a executes service events and collects waste in the storage container 420. The increasing packer load indicates that, as the storage container 420 becomes increasingly full of waste, the packer works harder to perform the compaction process. Accordingly, the trendline breaks after an ejection event, which empties the storage container 420 and lessens the work of the packer. As a result, the packer load data can be used to detect ejection events. From there, as the vehicle conducts additional service events and collects more waste in storage container 420, a new increasing trendline begins to form.

Packer load data can be used to reliably and accurately detect different states of a refuse collecting body, including (but not necessarily limited to) a volumetric fullness of the storage container 420. Volumetric fullness, in this context, provides an indication regarding how much of the storage container's refuse-containing volume is filled with waste or, alternatively, how much of the volume remains unfilled. The volume taken up by the waste is distinct from the weight of the waste. Although these characteristics may correlate in some instances, in others, they may diverge. For example, a refuse collecting vehicle may reach the volumetric fullness limit of the storage container before reaching any weight limit(s), or vice versa.

In some examples, the operational sensor data 146 includes data indicating the number of service events performed by the vehicle. The number of service events performed by the vehicle can be determined, for example, by monitoring operations of a lift arm 428. For example, the operational sensor data 146 can include information indicating a number of times the lift arm 428 has lifted to empty a container 402 into the storage container 420.

The vehicle 155a can include a battery 430, or multiple batteries. For example, the vehicle 155a can include a chassis battery, a body battery, a shared battery, or any combination of these. A chassis battery provides electrical power to the vehicle chassis in order to power movement of the vehicle. A body battery provides electrical power to the body components 404 of the vehicle. A shared battery is shared between the chassis and the body such that the shared battery provides electrical power to both the chassis and the body.

The battery 430 can generate battery charge data 440 describing the operations and/or status of the battery 430. The battery charge data 440 can include a state of charge of a battery, a battery capacity of the battery, a discharge rate of the battery, or any combination thereof.

In some implementations, the operational sensor data 410 and battery charge data 440 may be communicated from the body sensor devices 406 and the battery 430, respectively, to an onboard computing device 412 in the vehicle 155a. In some instances, the onboard computing device is an under-dash device (UDU), and may also be referred to as the Gateway. Alternatively, the device 412 may be placed in some other suitable location in or on the vehicle. The operational sensor data 410 and/or battery charge data 440 may be communicated from the sensors and battery, to the onboard computing device 412, over a wired connection (e.g., an internal bus) and/or over a wireless connection. In some implementations, a J1939 bus connects the various sensors and/or batteries with the onboard computing device. In some implementations, the sensors and/or batteries may be incorporated into the various body components. Alternatively, the sensors and/or batteries may be separate from the body components. In some implementations, the sensors and/or batteries digitize the signals that communicate the sensor data and/or image data, before sending the signals to the onboard computing device, if the signals are not already in a digital format.

The onboard computing device 412 can include one or more processors 414 that provide computing capacity, data storage 416 of any suitable size and format, and network interface controller(s) 418 that facilitate communication of the device 412 with other device(s) over one or more wired or wireless networks.

In some implementations, the analysis of the operational sensor data 410 and/or battery charge data 440 is performed at least partly by the onboard computing device 412 (e.g., by processes that execute on the processor(s) 414). For example, the onboard computing device 412 may execute processes that perform an analysis of the operational sensor data 410 to detect the presence of a condition such as a lift arm 428 being in a particular position in its cycle to empty a container into the hopper of the vehicle. In some implementations, the onboard computing device 412 transmits vehicle information 146 that include at least a portion of the operational sensor data 410 and/or battery charge data 440 to the route management system 120.

In some instances, the onboard computing device 412 can transmit, to the route management system 120, a location of the vehicle 155a, as determined through a satellite-based navigation system such as the global positioning system (GPS), or through other techniques. In such instances, the onboard computing device 412 can include location sensor device(s) 448, such as GPS receivers or other types of sensors that enable location determination. The location sensor(s) can generate location data 444 that describes a current location of the vehicle 155a at one or more times.

In the example of FIG. 4, the vehicle information 146 including the operational sensor data 410, the battery charge data 440, and/or the location data 444 are sent to the route management system 120. The routing model 110 executing on the route management system 120 generates the charging assignments 132 and the route assignments 134. In some implementations, the routing model 110 can include one or more machine learning models.

FIG. 2 depicts an example routing model 110 for managing refuse collection vehicle battery charging. In some examples, the routing model 110 employs one or more optimization algorithms. In some examples, the routing model 110 includes one or more machine learning models.

The routing model 110 processes the charger information 124, the vehicle information 146, and the environmental information 122 to provide the charging assignments 132 and the route assignments 134. The routing model 110 can use route optimization techniques to evaluate various assignment options in order to improve efficiency of the use of the chargers 130 by the vehicles 155 while ensuring the vehicles 155 have adequate power supplies to perform upcoming routes. An assignment option can include an assignment of a vehicle to a route or routes, an assignment of a vehicle to a charger, or both. For each evaluated option, the routing model 110 can evaluate corresponding charging needs for the fleet 150 of refuse collection vehicles 155.

The routing model 110 can include one or more modules and can perform one or more optimizations of objective functions. For example, the routing model 110 can perform charger utilization optimization, charging time minimization, vehicle charging minimization, battery cycling optimization, container capacity optimization, or any combination of these. The optimization operations can include balancing trade-offs between total charging time, total number of vehicles charged, and margin to minimum battery charge requirements. The optimization operations can be performed subject to constraints such as a total number of available refuse collection vehicles, a total number of available chargers, a total amount of available charging time, a total storage capacity of refuse collection vehicle containers, and/or other constraints.

The routing model 110 can include a charger utilization optimization module 202. The charger utilization optimization module 202 can optimize an objective function for the utilization of the chargers 130 for a specified time duration and/or time period. The specified time duration can be, for example, a ten hour time period between 8 pm and 4 am. The charger utilization optimization module 202 can generate charging assignments 132 and route assignments 134 that maximize the utilization of the set of chargers 130 for the specified time duration, subject to constraints. For example, the charging assignments 132 can optimize charger utilization by occupying all available chargers for the entire specified time duration, or the maximum possible percentage of the specified time duration. In some examples, the charging assignments 132 optimize charger utilization by minimizing an amount of time that any charger goes unused during the specified time duration.

The routing model 110 can include a charging time minimization module 204. The charging time minimization module 204 can optimize (e.g., minimize) an objective function for the total amount of charging time for the fleet 150 of vehicles. For example, charging time minimization 204 can generate charging assignments 132 and route assignments 134 that result in the least amount of charging time required to provide enough battery power to enough vehicles 155 in the fleet to accomplish all scheduled routes.

The routing model 110 can include a vehicle charging minimization module 206. The vehicle charging minimization module can optimize (e.g., minimize) an objective function for the total number of vehicles in the fleet that need to be charged in order to accomplish all service events assigned to the fleet. For example, the vehicle charging minimization module 206 can generate charging assignments 132 and route assignments 134 that result in the fewest number of vehicles that need to be charged in order to provide enough battery power to enough vehicles to perform all scheduled service events.

The routing model 110 can include a battery cycling optimization module 208. The battery cycling optimization module 208 can optimize an objective function for battery cycling across the fleet 150 of vehicles. Battery life can be improved by certain charging and discharging behaviors. Behaviors can include keeping the state of charge of the battery of each of the refuse collection vehicles 155 in the fleet between an upper bound (e.g., 80%) and a lower bound (e.g., 20%) and charging the batteries at optimal speeds. The battery cycling optimization module 208 can generate charging assignments 132 and route assignments 134 that optimize battery cycling for the batteries of each of the refuse collection vehicles 155 while enabling performance of all scheduled routes.

The routing model 110 can include a container capacity optimization module 212. The container capacity optimization module 212 optimizes an objective function for the utilization of container capacity of the fleet 150 of refuse collection vehicles 155. For example, the container capacity optimization module 212 can generate charging assignments 132 and route assignments 134 that result in the fewest number of vehicles that need to empty their containers prior to performing their next assigned route that provides enough container capacity to perform all scheduled service events. This can reduce the amount of time spent by refuse collection vehicles 155 travelling to and from the transfer station to empty their respective storage containers, and can reduce the amount of energy consumed to transport the vehicles to and from the transfer station.

In some examples, the routing request 108 specifies one or more objective functions of the fleet 150 to be optimized. For example, the routing request 108 can specify that the objective function for the total charging time required to perform the scheduled service events should be minimized (e.g., by the charging time minimization module 204). In some examples, the routing request 108 specifies a priority ranking of objective functions of the fleet to be optimized. For example, the routing request can specify that the first priority is to minimize the objective function for the total charging time required to perform the scheduled service events, and the second priority is to minimize the objective function for the total number of vehicles to be charged in order to perform the scheduled service events (e.g., by the vehicle charging minimization module 206).

The route management system 120 can output charging assignments 132 to the refuse collection vehicles 155, to the user device 109, or both. The charging assignments 132 can include, for each refuse collection vehicle 155, an assignment to charge a battery of the refuse collection vehicle or not to charge the battery of the refuse collection vehicle. In some examples, the charging assignments 132 indicate, for a particular refuse collection vehicle, a time duration for charging, a final state of charge for the battery after charging, an assigned charger, an assigned charger type (e.g., rapid charger, ultra-rapid charger), or any combination of these. The final state of charge for the battery can be a state of charge that is sufficient for performing the assigned route, and may be less than 100%.

A refuse collection vehicle can include more than one battery. For example, the refuse collection vehicle can include a chassis battery for the chassis and a separate body battery for the body. A chassis battery provides electrical power to the vehicle chassis in order to power movement of the vehicle. A body battery provides electrical power to the body components of the vehicle. In some examples, the refuse collection vehicle includes a battery that is shared between the chassis and the body. For a refuse collection vehicle with both a chassis battery and a body battery, the charging assignments 132 can include assignments to charge the chassis battery, the body battery, both, or neither, prior to beginning performance of the assigned route. For a refuse collection vehicle with a single battery, the charging assignments 132 can include an assignment to charge the battery or not to charge the battery prior to beginning performance of the assigned route.

The route management system 120 can output route assignments 134 to the refuse collection vehicles 155, to the user device 109, or both. The route assignments 134 can include, for each scheduled route in the database 140, at least one assigned refuse collection vehicle. In some examples, the route assignments 134 include a first refuse collection vehicle assigned to a first leg of a route, and a second refuse collection vehicle assigned to a second leg of a route. The route assignments 134 can include starting and ending locations, and starting and ending times, for each leg of each route.

In some examples, the route management system 120 outputs the route assignments 134 to the user device 109 in the form of a document such as a schedule and/or a spreadsheet. In some examples the route management system 120 outputs the route assignments 134 to the refuse collection vehicles 155 in the form of display data to be rendered by a display device in the vehicle. In some examples the route management system 120 outputs the route assignments 134 to mobile devices of operators of the refuse collection vehicles 155. The route assignments can be provided in the form of display data to be rendered by displays of the mobile devices, in the form of documents such as schedules or spreadsheets, or any combination thereof.

In some examples, the route assignments 134 indicate whether or not the assigned vehicle is to empty the storage container of the vehicle before beginning the assigned route. The route management system 120 can determine capacity of the storage container of the vehicle based on estimating fullness of the storage container, as described with reference to FIG. 4. Fullness of the storage container can be estimated, for example, using packer load sensor data, weight sensor data, camera image data, lidar sensor data, radar sensor data, ultrasonic sensor data, or any combination thereof.

In some examples, the route management system 120 can determine that the storage container of the vehicle has sufficient available capacity to perform the route and conduct all assigned service events along the route, and the route assignment 134 indicates that the vehicle is not to empty the container before performing the route. The route management system 120 can determine that the storage container of the vehicle has insufficient available storage capacity to perform the route and conduct all assigned service events along the route, and the route assignment 134 indicates that the vehicle is to empty the container before performing the route.

In some examples, a route assignment 134 can include an assignment of an autonomous refuse collection vehicle to a scheduled route. The route management system 120 can transmit instructions to the autonomous refuse collection vehicle indicating the assignment to the scheduled route. In some examples, the route management system 120 can transmit the instructions to a communications device of the autonomous refuse collection vehicle using wireless communications. The instructions can include navigation instructions directing the autonomous refuse collection vehicle to arrive at a starting location for the route at or before a target starting time for the route. In some examples, the instructions include navigation instructions from the starting location for the route to an ending location for the route, as well as locations (e.g., GPS coordinates) of service events scheduled along the route.

In some examples, the route management system 120 transmits, to an autonomous refuse collection vehicle, instructions to charge a battery of the autonomous refuse collection vehicle. The instructions can include navigation instructions directing the autonomous refuse collection vehicle to a location of a charging station and/or to a location of an assigned charger.

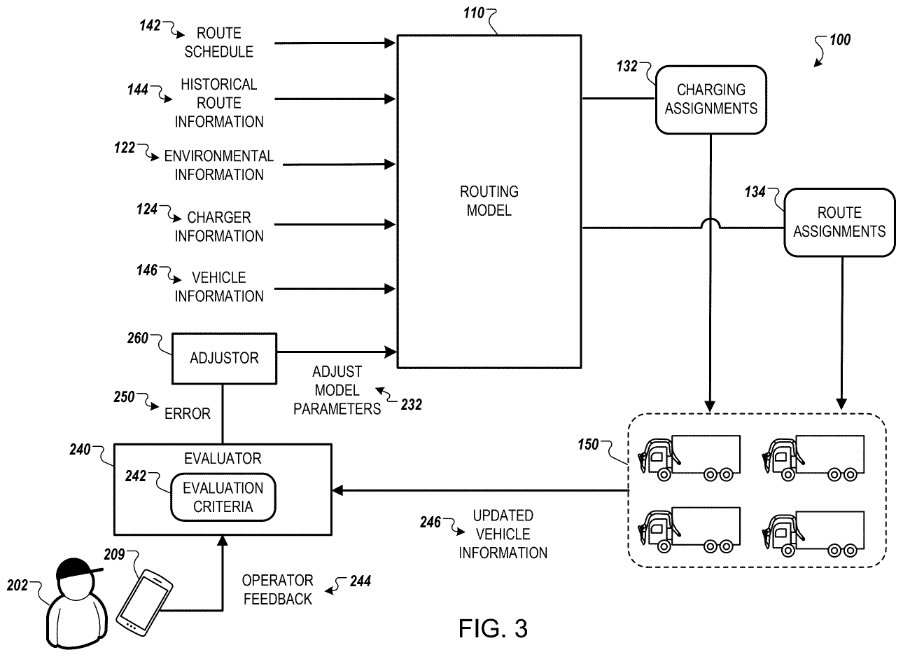

FIG. 3 depicts an example system for training a routing model 110 for managing refuse collection vehicle battery charging. The routing model 110 can receive, as input data, any of the following: route schedule information 142, historical route information 144, environmental information 122, charger information 124, and vehicle information 146.

In some examples, the routing model 110 employs one or more algorithms to generate the charging assignments 132 and the route assignments 134 from the input data. The one or more algorithms can include comparing input information to initial conditions for individual routes, and assigning a refuse collection vehicle to a route when the refuse collection vehicle satisfies the initial conditions for the route.

In some examples, the route management system 120 determines the initial conditions for each collection route of the set of collection routes. The route management system 120 can determine the initial conditions based on historical route information 144. The historical route information 144 can include information obtained during multiple instances of route performance over a period of time. For example, a particular route may be performed every Tuesday for a duration of a year, for a total of 52 instances of performance of the particular route. Information obtained during each of the 52 instances of performance of the particular route can be collected by the route management system 120 and stored as historical route information 144.

In some examples, the historical route information 144 includes a time duration of multiple instances of route performance. For example, the historical route information 144 can include a time duration of each performance of the particular route.

In some examples, the historical route information 144 includes an amount of battery power consumed during multiple instances of performance of the route. For example, the historical route information 144 can include a battery consumption of the refuse collection vehicle during each performance of the particular route. The battery consumption can be represented by a percentage (e.g., 60% reduction in battery state of charge during the route) or as a measure of an amount of energy (e.g., 16 kilowatt hours (kWh) consumed during the route), or by another measure. The battery consumption of the refuse collection vehicle can be determined using vehicle information 146 received from vehicles before, during, and/or after performance of the route. The vehicle information 146 can indicate a state of charge of the battery of the vehicle. In some examples, a battery sensor can automatically detect and transmit battery charge information to the route management system 120 (e.g., continuously, periodically, and/or in response to a trigger). A trigger for sending the battery charge information can include, for example, the vehicle accelerating above a threshold speed and/or decelerating below a threshold speed. In some examples, a trigger for sending the battery charge information includes detection of a particular number of service events (e.g., by detecting motion of the lift arm at least a threshold number of times).

In some examples, the historical route information 144 includes an amount of the container storage of the vehicle that was filled during multiple instances of performance of the route. For example, the historical route information 144 can include a capacity utilization of the storage container during each instance of performance of the particular route. The capacity utilization of the storage container can be represented by a percentage (e.g., 30% reduction in container storage capacity during the route) as a measure of volume (e.g., five cubic yards filled during the route), or by another measure. The route management system 120 can determine capacity utilization of the storage container of the vehicle based on estimating fullness of the storage container, as described with reference to FIG. 4. Fullness of the storage container can be estimated, for example, using packer load sensor data, weight sensor data, camera image data, lidar sensor data, radar sensor data, ultrasonic sensor data, or any combination thereof. In some examples, the historical route information 144 includes a number of service events performed during multiple instances of performance of the route. For example, the historical route information 144 can include a number of service events performed by the refuse collection vehicle during each instance of performance of the particular route. The number of service events performed by the vehicle can be determined, for example, by monitoring operations of a lift arm 428. For example, the operational sensor data 146 can include information indicating a number of times the lift arm 428 has lifted to empty a container 402 into the storage container 420.

In some examples, the historical route information 144 indicates environmental conditions during performance of the route. For example, the historical route information 144 can include temperature values, precipitation conditions, and/or wind conditions during each instance of performance of the particular route. The environmental conditions can be determined using environmental sensors 112 such as temperature sensors, humidity sensors, wind sensors, or any combination thereof. The environmental sensors 112 can generate and/or provide environmental information 122 to the route management system 120. In some examples, environmental sensor(s) can automatically transmit environmental information 122 to the route management system 120 (e.g., continuously, periodically, and/or in response to a trigger). A trigger for sending the environmental information 122 can include, for example, a value of an environmental condition satisfying a threshold value or a change in an environmental condition satisfying a threshold change. The environmental information 122 collected during a route can be stored in the database 140 with the corresponding historical route information 144. For example, the historical route information 144 can include a set of data entries, with one data entry for each instance of performance of a particular route, each data entry of the set of data entries can include the corresponding environmental information 122 that was collected during the instance.

In some examples, the historical route information 144 includes identities of vehicle operators (e.g., drivers) during performance of the route. For example, the historical route information 144 can include an assigned operator of the refuse collection vehicle during each instance of performance of the particular route.

In some examples, the historical route information 144 includes average values related to performance of the route (e.g., average time duration of performance of the particular route). In some examples, the historical route information 144 includes values associated with various route factors. For example, the historical route information 144 can include an average time duration of performance of the particular route during clear weather conditions, average time duration of performance of the particular route during rainy weather conditions, and average time duration of performance of the particular route during snowy weather conditions. In another example, the historical route information 144 can include an average battery consumption during performance of the particular route when Operator A is operating the vehicle, and an average battery consumption during performance of the particular route when Operator B is operating the vehicle.

The route management system 120 can determine the initial conditions for the routes based on the historical route information 144. For example, the route management system 120 can determine the initial conditions for the particular route based on any of the following information for the particular route: travel distance, number of assigned service events, average time duration, average number of performed service events, average battery consumption, and/or average container capacity utilized. The initial conditions can indicate the criteria for assigning a refuse collection vehicle to the particular route. As an example, the initial conditions can include a minimum battery state of charge of 70% and a minimum available container storage capacity of ten cubic yards.

In some examples, the initial conditions can vary based on one or more factors. For example, the initial conditions at higher environmental temperature may specify a higher minimum battery state of charge than initial conditions at a lower environmental temperature.

In some implementations, the routing model 110 can include one or more machine learning models. The machine learning models can be trained using training data. The training data can include many (e.g., millions) of training samples. The training data can include any of the following: route schedule information 142, historical route information 144, environmental information 122, charger information 124, and vehicle information 146.

A machine learning model can be, for example, a deep learning model that employs multiple layers of models to generate an output for a received input. In some cases, the machine learning model can include a neural network such as a recurrent neural network or a convolutional neural network. In some implementations, the machine learning model is a combination of models that may include all or a subset of the architectures described above.

In some implementations, the machine learning model can be a supervised model. For example, for each input provided to the model during training, the correct output can be provided as feedback to the machine learning model. In some implementations, the machine learning model can be an unsupervised model. For example, the model may adjust itself based on mathematical distances between examples rather than based on receiving feedback.

The routing model 110 processes the input data and outputs charging assignments 132 and route assignments 134. The routing model 110 can be trained using feedback. In some cases, the routing model 110 can be trained during a training period, prior to deployment. In some cases, the routing model 110 can be trained and/or can continue to be trained after deployment.

In general, training the routing model 110 can include obtaining updated vehicle information during performance of an assigned route, and updating parameters of the one or more machine learning models based on the updated vehicle information. The updated vehicle information 246 can include the same types of information as the vehicle information 146, obtained at a later time. For example, the vehicle information 146 can include a battery charge of a vehicle at a first time, and the updated vehicle information 246 can include a battery charge of the vehicle at a second, later time.

In some implementations, training the routing model 110 can include obtaining updated vehicle information after performance of the assigned route, and updating parameters of the one or more machine learning models based on the updated vehicle information. In some implementations, training the routing model 110 can include obtaining user feedback indicating an evaluation of success of performance of the route, and updating parameters of the one or more machine learning models based on the user feedback.

The feedback used to train the routing model 110 can include operator feedback 244. The operator feedback 244 can be received, for example, through an operator device 209. The operator feedback 244 can include an evaluation of success of the performance of the route. For example, the operator feedback 244 can include information indicating whether a particular refuse collection vehicle was able to complete the entire assigned route without charging a battery of the refuse collection vehicle. The operator feedback 244 can include information indicating whether a particular refuse collection vehicle was able to complete the entire assigned route without emptying the container of the refuse collection vehicle. The operator feedback 244 can include information indicating whether the time required for the particular refuse collection vehicle to complete the entire assigned route was satisfactory. The operator feedback 244 can include information indicating whether the utilization of the storage container of the refuse collection vehicle to perform the route was satisfactory.

The feedback used to train the routing model 110 can include updated vehicle information 246. The updated vehicle information can be obtained during performance of the route, after performance of the route, or both. The updated vehicle information 246 can include an updated battery state of charge of the battery of the refuse collection vehicle. The updated vehicle information 246 can include an updated container fullness of the refuse collection vehicle. The updated vehicle information 246 can include an updated operational status of the refuse collection vehicle. The updated vehicle information 246 can include a number of service events performed (e.g., based on lift arm sensor data), number of dumps at landfill performed on route (e.g., based on tailgate sensor), or any combination thereof.

An evaluator 240 can compare the updated vehicle information 246 and/or the operator feedback 244 to evaluation criteria 242 to determine an error 250 for the routing model 110. An adjustor 260 can adjust parameters 232 of the routing model 110 based on the error 250. Thus, the routing model 110 can be trained over time, reducing the error between the updated vehicle information 246 and/or the operator feedback 244 and the evaluation criteria 242. The trained routing model 110 be used to generate the charging assignments 132 and the route assignments 134.

In an example, the evaluation criteria 242 can specify a minimum final battery state of charge (e.g., 20%) of a battery of a refuse collection vehicle following performance of the assigned route. After a particular refuse collection vehicle completes the assigned route, the evaluator 240 can receive updated vehicle information 246 indicating a final battery state of charge of 15% for the particular refuse collection vehicle. The evaluator can therefore determine an error of 5% between the updated vehicle information 246 and the evaluation criteria 242. The adjustor 260 can adjust model parameters 232 of the routing model 110 based on the error of 5%. Over time, due to adjusting the model parameters 232 of the routing model 110, the error 250 can be reduced.

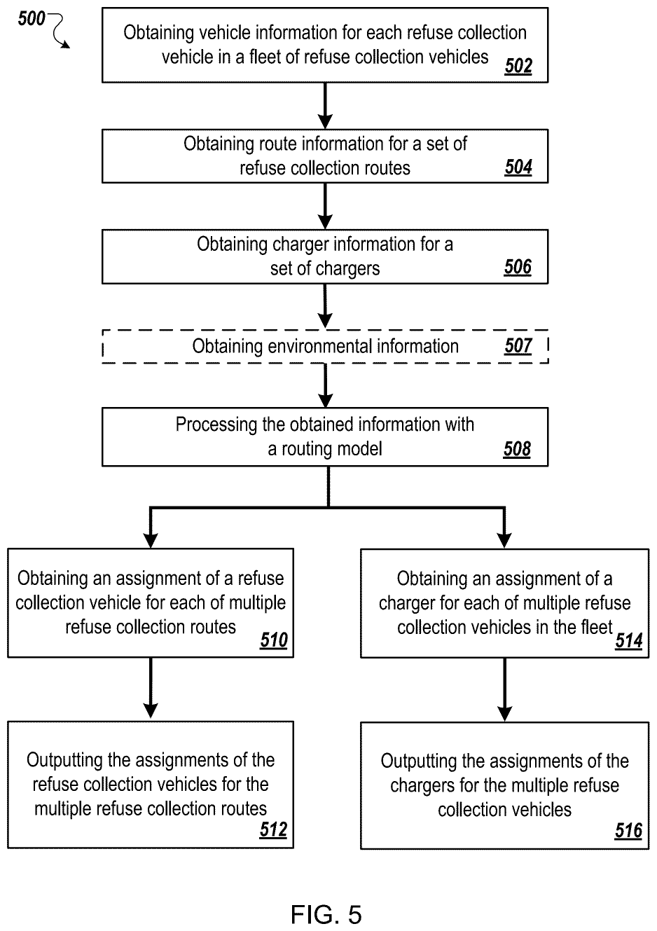

FIG. 5 is a flowchart of a process 500 for managing refuse collection vehicle battery charging and routing. Operations of the process 500 can be performed by one or more of the route management system 120, the vehicles 155, the chargers 130, the user device 109, and/or software module(s) executing on the route management system 120, the vehicles 155, the chargers 130, the user device 109, and/or elsewhere.

The process 500 includes obtaining vehicle information for each refuse collection vehicle in a fleet 150 of refuse collection vehicles (502). In some examples, the vehicle information for a refuse collection vehicle includes battery charge data for at least one battery of the refuse collection vehicle. The battery charge data can include a state of charge of a battery, a battery capacity of the battery, a discharge rate of the battery, or any combination thereof. The battery of the refuse collection vehicle can be a chassis battery or a body battery. A chassis battery provides electrical power to the vehicle chassis in order to power movement of the vehicle. A body battery provides electrical power to body components of the vehicle (e.g., body components 404 of the refuse collection vehicle 155a). In some examples, the refuse collection vehicle includes a battery that is shared between the chassis and the body.

In some examples, the vehicle information includes a volumetric fullness of a storage container of each refuse collection vehicle of the fleet 150 of refuse collection vehicles. The volumetric fullness can be expressed as a percentage (e.g., 35% full, 65% empty), as a volume occupied (e.g., 10 cubic yards occupied), as a volume unoccupied (e.g., 20 cubic yards unoccupied), or any combination of these. In some examples, the vehicle information includes a capacity of a storage container of each refuse collection vehicle of the fleet 150 of refuse collection vehicles.

In some examples, the vehicle information includes an operational status of each vehicle of the fleet 150 of refuse collection vehicles. For example, the operational status can be fully operational, partially operational, or not operational. A vehicle that is not operational can be a vehicle that is undergoing maintenance or is otherwise unavailable for performing a refuse collection route. A vehicle that has an operational status of fully operational might have no operational restrictions other than those indicated by the vehicle specifications. A vehicle that has an operational status of partially operational can have one or more operational restrictions. An operational restriction can be, for example, a maximum speed for the vehicle that is less than indicated by the vehicle specifications. In another example, the operational status of a vehicle can indicate an operational restriction of a maximum continuous travel distance that is less than indicated by the vehicle specifications. In another example, an operational restriction can indicate a minimum or maximum environmental temperature at which the vehicle can be operated.

The process 500 includes obtaining route information for a set of refuse collection routes (504). The set of refuse collection routes can include refuse collection routes to be performed in a geographic region over a specified time period. In some examples, the specified time period corresponds to a length of a work shift for operators of the refuse collection vehicles. In some examples, the specified time period is one day or more. In some examples, the specified time period is one week or less. In some examples, the specified time period includes the next day or multiple next days from the time when the process 500 is performed. For example, the process 500 can be performed on a Monday afternoon, after conclusion of performance of the routes that were scheduled for Monday. The process 500 can be performed to assign a set of refuse collection routes for the next day (Tuesday), the next two days (Tuesday and Wednesday) the next three days (Tuesday, Wednesday, and Thursday), or the next four days (Tuesday, Wednesday, Thursday, and Friday).

In some examples, the specified time period includes the next business days or multiple next business days from the time when the process 500 is performed. For example, the process 500 can be performed on a Friday afternoon, after conclusion of performance of the refuse collection routes that were scheduled for Friday. The process 500 can be performed to assign a set of refuse collection routes for the next business day (Monday), the next two business days (Monday and Tuesday), etc., while omitting weekend days.

For a particular route, the route information can include a length of the route, a predicted duration of the route, a number of service events assigned to the route, predicted battery power consumption for the route, or any combination thereof.

In some examples, the route information includes a set of initial conditions for the route. The set of initial conditions can include requirements for a refuse collection vehicle to be assigned to the route. The set of initial conditions can include, for example, a minimum battery state of charge required for a refuse collection vehicle to perform the route, a minimum storage container capacity availability required for a refuse collection vehicle to perform the route, or both. The minimum battery state of charge can be, for example, a specified percentage (e.g., at least 50% charge) or a specified remaining capacity (e.g., 30 kWh). The minimum storage capacity availability can be, for example, a specified percentage (e.g., at least 40% capacity available) or a specified volumetric availability (e.g., at least twenty cubic yards available).

In some examples, the set of initial conditions varies depending on environmental conditions. For example, at a higher temperature, a minimum battery state of charge required for a refuse collection vehicle to perform a particular route may be 20 kWh, and at a lower temperature the minimum battery state of charge for a refuse collection vehicle to perform the particular route may be 25 kWh.

The route information can include a schedule for when the route is to be performed. For example, a first route may be scheduled to be performed weekly on Mondays, and a second route may be scheduled to be performed on both Tuesdays and Thursdays.

The process 500 includes obtaining charger information for a set of chargers (506). In some examples, the charger information indicates an operational status of each charger in the set of chargers. For example, the operational status can be fully operational, partially operational, or not operational. A charger that has an operational status of fully operational might have no operational restrictions. A charger that has an operational status of partially operational can have one or more operational restrictions (e.g., a maximum charging rate, a maximum charging time, a minimum or maximum environmental temperature at which the charger can be operated). A charger that is not operational can be a charger that is undergoing maintenance or is otherwise unavailable for charging batteries. The charger information can include a charging rate of the charger, one or more electrical specifications of the charger, a location of the charger, or any combination thereof. The charger information an include an availability of the charger, such as whether the charger is currently in use and/or a schedule for planned use of the charger.

In some examples, the process 500 includes obtaining environmental information for a geographic region that includes the set of routes (507). The process 500 can include assigning the refuse collection vehicles to the respective routes based on the vehicle information, the route information, and the environmental information. The environmental information can be obtained from a weather service, environmental sensors, or both. In some examples, the environmental sensors are mounted to refuse collection vehicles. In some examples, the environmental information includes temperature, precipitation, and wind conditions.

The process 500 includes processing the vehicle information, the route information, and the charger information with a routing model (508). In some examples, the process 500 includes processing the vehicle information, the route information, the charger information, and environmental information with the routing model.

In some examples, the routing model includes one or more machine learning models. The routing model can assign refuse collection routes and charging assignments to one or more refuse collection vehicles of the fleet 150 of refuse collection vehicles based on optimizing one or more objective functions. Objective function can include a function for any or all of the following: charger utilization, a total battery charging time for the fleet of vehicles, a total number of vehicles to be charged, battery cycling for the fleet of vehicles, and a utilization of storage container capacity for the fleet of refuse collection vehicles. In some examples, the objective functions are selected based on user input. For example, the process 500 can include receiving user input specifying the objective function(s) to be optimized and/or a priority ranking of objective functions to be optimized.

The process 500 includes obtaining, as output from the routing model, an assignment of a refuse collection vehicle for each of multiple refuse collection routes (510). In some examples, the process 500 includes assigning, using the routing model, the refuse collection vehicles based on the vehicle information, the route information, and the charger information.

In some examples, assigning a vehicle to a route includes determining, based on the vehicle information, that the vehicle satisfies the initial conditions for the route. In some examples, assigning a vehicle to a route includes determining, based on the vehicle information, that the vehicle does not satisfy the initial conditions for the route, and identifying one or more actions that would result in the vehicle satisfying the initial conditions for the route. In some examples, the actions include emptying the storage container. In some examples, the actions include charging the battery.

The route assignments determined by the model can be selected to maximize charging efficiency and reduce the total amount of charging of vehicles in the fleet required to perform the service events along the routes.

In an example scenario, the routing model 110 can evaluate assigning a particular vehicle to two candidate routes: a longer route and a shorter route. Based on the charger information 124, the routing model 110 may determine that a nearby charger is available for a long enough time duration to charge the particular vehicle to a battery charge state necessary for performing the shorter route, but not a long enough time duration to charge the particular vehicle to a battery charge state necessary for performing the longer route. Therefore, the routing model 110 can generate a charging assignment 132 that assigns the particular vehicle to the nearby charger, and can generate a route assignment 134 that assigns the particular vehicle to the shorter route.

The process 500 includes outputting the assignments of the refuse collection vehicles for the multiple refuse collection routes (512). In some examples, outputting the assignments includes outputting display data to an assigned refuse collection vehicle for presentation by a display of the refuse collection vehicle. The display data can indicate the assigned route.

The process 500 includes obtaining, as output from the routing model, an assignment of a charger for each of multiple refuse collection vehicles in the fleet (514).

The process 500 includes outputting the assignments of the chargers for the multiple refuse collection vehicles (516). The assignments can instruct, for each refuse collection vehicle, whether to charge the battery. The assignments can instruct, for each refuse collection vehicle, a time duration of battery charging. The assignments can instruct, for each assigned refuse collection vehicle, a final state of charge for the battery. The assignments can instruct, for each assigned refuse collection vehicle, an assigned charger and/or type of charger. The assignments can instruct, for each assigned refuse collection vehicle, an assigned rate of battery charge.

In some examples, outputting the assignments includes transmitting instructions to the assigned charger to charge the vehicle for a specified time duration or to a specified final state of charge. The specified final state of charge can be a state of charge that is sufficient for the assigned route.

In some examples, the fleet includes autonomous refuse collection vehicles. Outputting the assignments can include transmitting instructions to the autonomous refuse collection vehicles to charge at the assigned charger, to perform the assigned route, or both.

Although examples herein may show and/or describe implementations for particular types of RCVs, implementations are not limited to these examples. The structures and/or methods described herein can apply to any suitable type of RCV, including front-loader, rear-loader, side-loader, roll-off, and so forth, with or without Curotto-Can™, carry can, and so forth.

Although examples herein may show and/or describe implementations for RCVs, implementations are not limited to these examples. The structures and/or methods described herein can apply to any suitable type of electric vehicle, including buses, airport transit vehicles (e.g., aircraft tugs, airport transit buses, baggage carts), material handling equipment (e.g., forklifts, parts delivery shuttles), etc. The disclosed techniques can apply to vehicles that have pre-planned routes and/or routes of predictable distance, speed, and/or duration.

Advantages of the disclosed techniques can include any of the following. In some examples, the long term life cycle of vehicle batteries can be improved. Vehicle batteries can be charged and discharged to optimal or near-optimal levels. In some examples, a total number of charge/discharge cycles for a vehicle battery can be reduced. The total number of vehicle chargers needed to charge a fleet 150 of refuse collection vehicles can be reduced. Multiple vehicles can be charged with a single charger, due to reducing unnecessary charging operations.

The controllers, control units and/or computing devices described throughout this disclosure can include or employ one or more computing systems. FIG. 6 depicts an example computing system 600. The system 600 may be used for any of the operations or functions described in this disclosure with reference to a computing device. For example, the system 600 may be included, at least in part, in the onboard computing device 412 and/or any other computing device(s) or system(s) associated with the refuse collecting vehicle 155a. The system 600 includes one or more processors 610, a memory 620, one or more storage devices 630, and one or more input/output (I/O) devices controllable via one or more I/O interfaces 640. The various components 610, 620, 630, or 640 may be interconnected via at least one system bus 660, which may enable the transfer of data between the various modules and components of the system 600.

The system bus 660 may include a series of wired or wireless connections. In some embodiments, the system bus includes a CAN network bus operating under the J1939 protocol.

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general purpose processor(s), special purpose processor(s), or both.

The memory 620 may store information within the system 600. In some embodiments, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some embodiments, the storage device(s) 630 may include one or more computer-readable media. For example, the storage device(s) 630 may include a floppy disk device, a hard disk device, an optical disk device, or a tape device. The storage device(s) 630 may include read-only memory, random access memory, or both. The storage device(s) 630 may include one or more of an internal hard drive, an external hard drive, or a removable drive.

One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some embodiments, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to semiconductor memory devices (such as EPROM, EEPROM, DRAM, and flash memory devices), magnetic disks (such as internal hard disks and removable disks), magneto-optical disks, and CD-ROM and DVD-ROM disks. In some examples, the processor(s) 610 and the memory 620 may be supplemented by, or incorporated into, one or more application-specific integrated circuits (ASICs).

The system 600 may include one or more I/O devices (not shown). The I/O device(s) may include one or more input devices such as a joystick, keypad, keyboard, a mouse, a pen, a game controller, a touch input device (e.g., a touch pad), an audio input device (e.g., a microphone), a gestural input device, a haptic input device, an image or video capture device (e.g., a camera), a mobile device, or other devices. In some examples, the I/O device(s) may also include one or more output devices such as a display, LED(s), an audio output device (e.g., a speaker), a printer, a haptic output device, and so forth. The I/O device(s) may be physically incorporated in one or more computing devices of the system 600, or may be external with respect to one or more computing devices of the system 600.

The system 600 may include one or more I/O interfaces 640 to enable components or modules of the system 600 to control, interface with, or otherwise communicate with the I/O device(s). The I/O interface(s) 640 may enable information to be transferred in or out of the system 600, or between components of the system 600, through serial communication, parallel communication, or other types of communication. For example, the I/O interface(s) 640 may comply with a version of the RS-232 standard for serial ports, or with a version of the IEEE 1284 standard for parallel ports. As another example, the I/O interface(s) 640 may be configured to provide a connection over Universal Serial Bus (USB) or Ethernet. In some examples, the I/O interface(s) 640 may be configured to provide a serial connection that is compliant with a version of the IEEE 1394 standard.

The I/O interface(s) 640 may also include one or more network interfaces that enable communications between computing devices in the system 600, or between the system 600 and other network-connected computing systems. The network interface(s) may include one or more network interface controllers (NICs) or other types of transceiver devices configured to send and receive communications over one or more communication networks using any network protocol.

Computing devices of the system 600 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some embodiments, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 600 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), embodiments are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

A number of embodiments have been described. Nevertheless, it will be understood that various modifications may be made without departing from the spirit and scope of the disclosure. Accordingly, other embodiments are within the scope of the following claim(s).

For example, although the vehicle described above is a refuse collection vehicle referred to as “garbage truck” that collects refuse or garbage, in some embodiments, such a vehicle is designed to collect a variety of different types of used or discarded materials—e.g., recyclables, hazardous materials, construction materials, etc.

As another example, although the cab of the refuse vehicle is described above as featuring a compartment for a human driver, in some embodiments, the refuse vehicle can be operated autonomously or semi-autonomously, or a combination thereof.

As yet another example, some embodiments of this disclosure can be implemented without a mobile vehicle chassis. For instance, the storage container and packer can be fixed in place on a ground surface.

As yet another example, although the refuse vehicle is described above as having front-loading lift, in some embodiments, the refuse vehicle may have a side-loading lift, and/or a rear-loading lift, or no lift at all.

As yet another example, although the service event described above includes certain specific operations of an automated dump cycle, the concept of a “service event” is more broadly understood and used in this disclosure. For example, in some embodiments, a service event may include a dump cycle including different operations or the same operations performed in a different order (or simultaneously). Additionally, in some embodiments, a service event may include some other manner of depositing waste (or other materials) onto the vehicle. For instance, a service event may include a human worker (or customer) placing the waste into a receptacle of the vehicle.

As yet another example, although the packer described above features an auger-style compactor, in some embodiments, the packer may include a translating packer blade.

As yet another example, although the auger drive described above is an electric drive featuring an electric motor, in some embodiments, the auger drive can take a variety of different forms. For instance, the auger drive may include a hydraulic, pneumatic, or a combustion-based prime mover. Moreover, in some examples, the auger drive may further include various transmission elements (e.g., gearing) to transmit power from the prime mover to the auger (or packer blade).

As yet another example, an addition to the above-described sensors for monitoring the lift, packer, and ejector, the refuse vehicle may further include sensors for monitoring a variety of other components, operations, and/or the vehicle's surrounding environment. Such sensors may take a variety of forms. For example, the sensors can include, but are not limited to, an analog sensor, a digital sensor, a controller area network (CAN) bus sensor, a magnetostrictive sensor, a radio detection and ranging (RADAR) sensor, a light detection and ranging (LIDAR) sensor, a laser sensor, an ultrasonic sensor, an infrared (IR) sensor, a stereo camera, a three-dimensional (3D) camera, or a combination thereof.

As yet another example, in some embodiments, the packer load data may include the integrated, aggregated, or otherwise combined output of multiple different sensors monitoring various aspects of the packer. As yet another example, in some embodiments, the packer load data output by the one or more sensors may include raw measured data and/or data pre-processed by the sensor(s). As yet another example, in some embodiments, data output from the one or more sensor(s) may be triggered by the occurrence of an event (e.g., activation of the auger/packer), occur at predetermined time intervals, and/or occur in response to a received request (e.g., from the logical controller).

As yet another example, although the information network is described above as an onboard wired data bus, in some embodiments, the network may take the form of a wireless network.

As yet another example, although the above-discussed embodiments include monitoring for service and eject events by receiving and processing sensor data, in some embodiments, such monitoring may account for user input by an operator and/or requests from a remote computing device.

As yet another example, although the above-discussed embodiments describe outputting an alert via an onboard user interface system, in some embodiments, such an alert can be conveyed to a remote computing device.

In some implementations, the above-described refuse collection vehicle is an all-electric vehicle or an at least partially electric vehicle. For example, one or more (e.g., all) motive power elements, body controls, and sub-systems of the refuse collection vehicle can be electrically powered by onboard battery packs.

1. A computer-implemented method performed by at least one processor, the method comprising:
obtaining vehicle information for a fleet of vehicles, the vehicle information comprising, for each vehicle of the fleet of vehicles, battery charge data for at least one battery of the respective vehicle;
obtaining, for each route of a plurality of routes, route information;
automatically assigning, for each route of the plurality of routes based on the vehicle information and the route information, a respective vehicle of the fleet of vehicles to a respective route of the plurality of routes; and
outputting assignment data that indicates the assigned vehicle for each of the plurality of routes.

2. The method of claim 1, wherein the vehicle information comprises at least one of:
a volumetric fullness of a storage container of each respective vehicle of the fleet of vehicles;
a capacity of a storage container of each respective vehicle of the fleet of vehicles; or
an operational status of each respective vehicle of the fleet of vehicles.

3. The method of claim 1, wherein the battery charge data comprises at least one of:
a state of charge of the at least one battery of the respective vehicle; or
a battery capacity of the at least one battery of the respective vehicle.

4. The method of claim 1, wherein the at least one battery comprises:
a chassis battery configured to provide electrical power to a chassis of the vehicle; or
a body battery configured to provide electrical power to one or more body components of the vehicle.

5. The method of claim 1, wherein the route information for a route of the plurality of routes comprises at least one of:
a length of the route;
a predicted duration of the route; or
a number of service events assigned to the route.

6. The method of claim 1, wherein:
the route information comprises a set of initial conditions for each route of a plurality of routes; and
assigning a vehicle to a particular route comprises determining, based on the vehicle information, that the vehicle satisfies the initial conditions for the particular route.

7. The method of claim 6, wherein the set of initial conditions comprises at least one of:
a minimum battery state of charge required to perform the respective route; or a minimum storage container capacity required to perform the respective route.

8. The method of claim 6, wherein the set of initial conditions varies depending on environmental conditions.

9. The method of claim 1, wherein:
the route information comprises a set of initial conditions for each route of a plurality of routes; and
assigning the respective vehicle to the respective route comprises:
determining, based on the vehicle information, that the respective vehicle does not satisfy the initial conditions for the respective route; and
identifying one or more actions that would result in the respective vehicle satisfying the initial conditions for the respective route; and
outputting instructions to perform the one or more actions that would result in the respective vehicle satisfying the initial conditions for the respective route.

10. The method of claim 9, wherein the vehicle information comprises a volumetric fullness of a storage container of the respective vehicle, and the one or more actions comprise emptying the storage container of the respective vehicle.

11. The method of claim 9, wherein the one or more actions comprise charging the at least one battery of the respective vehicle.

12. The method of claim 1, wherein the route information comprises:
a schedule for performance of the respective route; or
a predicted battery power consumption for the respective route.

13. The method of claim 1, wherein:
the route information comprises a set of initial conditions for the respective route, and
the method comprises determining, for each route of the plurality of routes based on historical route information, initial conditions for the respective route, the historical route information comprising at least one of:
a time duration of multiple instances of performance of the respective route;
battery power consumed during the multiple instances of performance of the respective route;
a number of service events performed during the multiple instances of performance of the respective route; or
environmental conditions during the multiple instances of performance of the respective route.

14. The method of claim 1, wherein the plurality of routes comprises a plurality of routes to be performed in a geographic region over a specified time period.

15. The method of claim 1, comprising:
obtaining charger information for each charger of a plurality of chargers; and
assigning the respective vehicle of the fleet of vehicles for each route of the plurality of routes based on the vehicle information, the route information, and the charger information, wherein the charger information indicates at least one of:
an operational status of the respective charger;
a charging rate of the respective charger;
one or more electrical specifications of the respective charger; or
a location of the respective charger.

16. The method of claim 1, wherein automatically assigning, for each route of the plurality of routes based on the vehicle information and the route information, a respective vehicle of the fleet of vehicles to a respective route comprises:
processing the battery charge data and the route information with a routing model; and
obtaining the assignment of each route to a respective vehicle as output from the routing model.

17. The method of claim 16, wherein the routing model comprises one or more machine learning models.

18. The method of claim 16, wherein the routing model assigns the vehicles based on optimizing at least one objective function.

19. The method of claim 18, wherein the method includes receiving user input specifying the at least one objective function to be optimized.

20. The method of claim 18, wherein the objective function comprises a function for at least one of:
a utilization of a plurality of chargers;
a total battery charging time for the fleet of vehicles;
a total number of vehicles to be charged;
battery cycling for the fleet of vehicles; and
a utilization of storage container capacity for the fleet of vehicles.

21. The method of claim 1, wherein the assignment data instructs, for each assigned vehicle, at least one of:
whether to charge the at least one battery of the vehicle;
a time duration of charging the at least one battery of the vehicle;
a final state of charge for the at least one battery after charging the at least one battery of the vehicle; or
an assigned charger for charging the at least one battery of the vehicle.

22. The method of claim 1, wherein:
the assignment data instructs, for a vehicle, an assigned charger for charging the at least one battery of the vehicle; and
outputting the assignment data includes transmitting instructions to the assigned charger to charge the vehicle for a specified time duration or to a specified state of charge.

23. The method of claim 1, wherein outputting the assignment data includes outputting, to a vehicle, display data for presentation by a display of the vehicle, wherein the display data shows the respective route.

24. The method of claim 1, wherein:
the fleet of vehicles includes at least one autonomous vehicle; and
outputting the assignment data comprises transmitting instructions to the at least one autonomous vehicle to perform the respective route.

25. The method of claim 1, wherein:
the fleet of vehicles comprises a fleet of refuse collection vehicles;
and the plurality of routes comprises a plurality of refuse collection routes.

26. A non-transitory computer program product storing instructions that, when executed by at least one programmable processor, cause the at least one programmable processor to perform operations comprising:
obtaining vehicle information for a fleet of vehicles, the vehicle information comprising, for each vehicle of the fleet of vehicles, battery charge data for at least one battery of the respective vehicle;
obtaining, for each route of a plurality of routes, route information;
automatically assigning, for each route of the plurality of routes based on the vehicle information and the route information, a respective vehicle of the fleet of vehicles to a respective route of the plurality of routes; and
outputting assignment data that indicates the assigned vehicle for each of the plurality of routes.

27. A system comprising:
at least one programmable processor; and
a machine-readable medium storing instructions that, when executed by the at least one processor, cause the at least one programmable processor to perform operations comprising:
obtaining vehicle information for a fleet of vehicles, the vehicle information comprising, for each vehicle of the fleet of vehicles, battery charge data for at least one battery of the respective vehicle;
obtaining, for each route of a plurality of routes, route information;
automatically assigning, for each route of the plurality of routes based on the vehicle information and the route information, a respective vehicle of the fleet of vehicles to a respective route of the plurality of routes; and
outputting assignment data that indicates the assigned vehicle for each of the plurality of routes.
